(19) United States
(12) Patent Application Publication
(10) Pub. No.: US 2004/0068990 A1
(43) Pub. Date: Apr. 15, 2004

(54) Method for the co-generation of heat & power in conjuction with high temperature heat needs

(76) Inventor: Athanasios Katsanevakis, Thessaloniki (GR)

Correspondence Address: KATSANEVAKIS ATHANASIOS, 2 V. KON/NOU STR., THESSALONIKI MACEDONIA, 552 36, GR

(21) Appl. No.: 10/678,113

(22) Filed: Oct. 6, 2003

(30) Foreign Application Priority Data
Apr. 9, 2001 (GR) 20010100180

(51) Int. Cl. F02C 1/00; F23B 7/00

(52) U.S. Cl. 60/772; 110/341

(57) ABSTRACT

Method of Cogeneration of Heat and Power where Electricity Generating Device(s)—EGD—exhaust gases are used as oxidiser in high temperature heat needs. This invention concerns a new method of applying cogeneration of heat and power in cases where generation of high temperature—up to 1500° C. or more—heat is needed locally in multiple positions. This method is characterised by the use of the EGD—Electricity Generating Device—exhaust gases—e.g. the exhaust gases of a turbine set—as oxidiser for the combustion of additional fuel in the kilns and the furnaces of high temperature industries—e.g. ceramics, heavy clay, glass, steel/metal, cement industry etc.—after exhaust gases have been increased their temperature in a heat exchanging process by cooling the processed material or the exhaust gases produced in the kiln or the furnace, eliminating the air which is usually used as oxidiser medium. It is additionally characterised by the ability to enrich EGD exhaust gases with a mixture of air and/or oxygen of various temperature levels and/or compositions before used as oxidiser. It is applicable in the above mentioned industries and other industry and applications where relatively high temperatures are needed.

The present invention concerns a method which permits the application of Cogeneration of Heat and Power with high total cycle efficiencies, in relation with heat needs of relatively high temperature levels as those used in kilns and furnaces in the e.g. ceramics and heavy clay industry, in re-heating kilns and furnaces in the steel/metal industry, in glass furnaces, in cement industry etc.

It is widely known that Cogeneration of Heat and Power uses more efficiently the available in the fuel energy than the separate generation of Power and Heat. In several cases one of the common obstacles of CHP applicability is the efficient use of the heat which is cogenerated with the power. In many practical cases this is the limiting factor for the applicability of cogeneration methods. Especially in cases where the heat which is needed by the process is of higher temperature level than that produced by the CHP method and, because of process needs, this heat should be generated locally at several distributed points, application of CHP is difficult. Examples include as mentioned above ceramics or heavy clay firing kilns, glass furnaces etc.

One approach to CHP at high temperatures is the use of gas turbine exhaust gases as oxidiser to burn additional fuel in the burners of the kiln and/or the furnace. Although this can be achieved theoretically, there are several problems encountered when high total CHP cycle efficiency and reliability is concerned.

One problem is that modern gas turbine sets include relatively low oxygen content in their TEG—Turbine Exhaust Gases—. This ranges between 13 and 16% for most modern gas turbines. Moreover for reasons of high electric efficiency, recuperative gas turbines are more often available resulting in lower turbine exhaust temperatures.

Another problem is that in most of the above industries a large number of relatively small burners is used to be able to accurately control process temperatures locally. This creates problems of reliable operation mainly of the small burners with the lean oxygen content TEG—ignition problems, stability of operation etc.—.

A third problem is that to reach the high temperatures usually needed in these industrial sectors a significant amount of fuel is needed to be burned in the burners of the kilns. This usually eliminates the advantages of applying CHP as there is small if not at all energy savings because the big amounts of heat generated by the kiln burners cannot be efficiently used in the process.

Finally in most of these industrial sectors preheated air is used as combustion air. Thus advantages in terms of energy savings when using TEG are eliminated unless an efficient method can be used instead.

### SUMMARY OF THE INVENTION

According to the present invention a novel method is used to overcome the above mentioned problems. The method concerns the use of the hot process material exiting the firing zones of the kiln, or the use of the hot gases exiting the high temperature environment of the furnace, or both. These can be cooled to increase the temperature of the TEG at higher temperatures than the temperature at the exit of the gas turbine set eliminating at the same time the air used as combustion air. Additionally and when needed, the TEG can be enriched with hot air and/or oxygen at various volume contents to reach stable combustion conditions in the kiln/furnace burners.

By applying this method all problems mentioned before can be efficiently faced: By increasing the TEG temperature using the hot material or the hot gases exiting the kiln more reliable operation of the burners can be achieved even at the low oxygen content of the TEG produced by the modern gas turbines. Additionally TEG preheated by the hot material or the hot gases has direct positive effect on the total efficiency of the cycle eliminating the amount of fuel needed in the burners to reach the desired high temperature of the process. On top of that it eliminates the amount of air used for the cooling of the material and as such it eliminates the amount of the preheated air used for the combustion because now this cooling is being performed by the TEG. Moreover this method permits the efficient use of recuperative turbines in co-operation with kilns and furnaces where high temperature heat is needed.

### DESCRIPTION OF THE PRIOR ART

The use of turbine based CHP sets is a usual CHP method and is based on the reliability of these units for continuous operation and relatively low service costs. It is known that the heat generated by the usual turbine sets is of relatively high temperature level—about 500° C.—is mainly in the form of hot exhaust gases and contain a significant amount of oxygen, 14-15% weight in modern gas turbines. Thus turbine exhaust gases can be used under several circumstances as oxidiser to burn additional fuel. This method is known to significantly increase the total thermodynamic efficiency of the whole process depending on the final exhaust gas temperature. This is the reason for the common use of turbine exhaust gases as oxidiser in large centrally located regenerative boilers where additional fuel is burned in special large burners to produce, with proper heat exchange, diathermic medium—usually steam—for the process needs. Then this medium is circulated in the plant to cover the local decentralised heat needs of the process. This forms a common practice in industry where turbine based CHP is used to produce process steam and/or diathermic oil. However in several industrial sectors there is no need for a diathermic medium while at the same time process consumes large amounts of Heat at relatively high temperatures. These industrial sectors, where the main interest of this invention is focused, is the heavy clay, ceramics, glass, steel/metal, and cement industry, not excluding other industrial sectors, where there is little or no need for process steam or diathermic oil. In these industrial sectors there is at the moment no way to apply Cogeneration of Heat and Power with acceptable total cycle efficiency levels. An exception is the use of CHP sets in conjuction with the drying heat needs in the heavy-clay and the ceramics industry. Besides this kind of CHP applications, there is no case where the heat produced by the CHP set is used in the kilns and the furnaces of these industrial sectors. However by using the heat of the CHP in the kilns and the furnaces in these industrial processes can give rise to several benefits this being the subject of the present invention. Because of the high temperatures needed by the process in these industrial sectors,—more than 800° C. and up to 1700° C.—only gas turbine exhaust gases—TEG—which contain an amount of oxygen—usually 13 up to 15% weight for the modern gas turbines—can be used in the kilns as there must be enough oxygen in the oxidiser to burn additional fuel and reach the desired process temperatures.

The use of TEG as oxidiser in high temperature processes is known mainly from the following publications:

U.S. Pat. No 4,528,012 A issued on 1^{st} of July 1982.

U.S. Pat. No 4,528,012 issued on 9^{th} of July 1985.

However the content of these patents is not related with the core problem faced by the present invention.

In U.S. Pat. No. 4,528,012 A a method for applying cogeneration in conduction with a glass furnace is described. This method does not use a typical gas turbine set but a purpose made turbine set where the heat needed to raise the temperature of the compressed air is given mainly by the process and is upgrated, when needed by a burner (heat exchanger 34 and burner 35 in FIG. 6 of the document). Moreover the gases exiting the turbine T is clean air (see description and claims 1&2 of the above patent), and not exhaust gases, thus not TEG. This approach have several disadvantages:

A specially constructed turbine is needed and not a gas-turbine set with the typical gas-turbine combustion chamber. The role of the gas turbine combustion chamber is been taken by the heat exchanger 34 and the burner 35 in FIG. 6 of the U.S. Pat. No. 4,528,012 A. This increases considerably the cost for applying this scheme. Moreover three duct lines are needed to connect the purpose made turbine with the process.

A more significant disadvantage is that the turbine cannot work to produce power if the process is off as it needs the heat generated in the process and the burner to heat the air in the heat exchanger 34 expand it and operate the turbine T. This eliminates considerably the benefits of CHP as this application is not an independed by the process and by the process variations, source of power. This means that turbine cannot generating power if the process shut down or stops.

U.S. Pat. No 4,528,012 deals mainly with the use of a gas seal in a process using—GTE as Turbine Exhaust—in a cracking furnace. The focus of the patent is not on the use of GTE but on the gas seal which is used for control purposes. However the GTE process described in the U.S. Pat. No. 4,528,012 is not related in any case with the inventive step of the present application which is the increase of the TEG temperature by the cooling of the hot material or the hot gases exiting the kiln before this—the TEG—used as oxidiser for the fuel to be burned in the kiln or the furnace burners.

### DESCRIPTION OF THE INVENTION

The present invention concerns the use of the exhaust gases generated by Electricity Generating Devices—EGD's—e.g. gas turbine sets or recuperative gas turbine sets or reciprocating engine sets etc.—as oxidiser, alone or in a mixture with air of various temperatures or even in a mixture with air and/or oxygen of various temperature levels for the combustion of additional fuel locally where distributed and individually controllable generation of heat is needed as in the kilns and the furnaces of the ceramics, heavy-clay, glass, steel/metal, cement and other high temperature industrial sectors. Exhaust gases are produced by the EGD(s). Exhaust gases may contain oxygen at various volume percentages usually between 10 and 16% weight according to the type and the construction of the EGD. Exhaust gases are heated by the hot processed material or the hot process exhaust gases which is cooled for process efficiency reasons giving their heat to the exhaust gases. Exhaust gases are so heated to, considerably, higher temperature than the temperature at their exit from the EGD. They are then guided to the points where decentralised generation of heat is needed. These points are usually distributed along the kilns according to the process temperature profile needed to be achieved in the kiln or in the furnace. There, specially constructed burners are used to burn additional fuel, each one using these exhaust gases as oxidiser either directly—gases are fed within the burner—or indirectly-gases are fed in furnace room—. The burners can be individually controlled to achieve process needs. If and when needed, turbine exhaust gases can be enriched by a mixture of air and/or pure oxygen of various temperature levels to achieve process conditions. Part or all of the gas-turbine exhaust gases increase their temperature before used as oxidiser at a temperature higher than the temperature exiting the gas turbine set, in a heat exchange process with the hot processed material exiting the firing zones of the kiln or in a heat exchanging process with the hot gases exiting the furnace or in a hybrid process where both hor material and gases are used to heat the EGD exhaust gases. Reheated EGD exhaust gases can also be used as oxidiser in regenerative or radiant or porous or flameless burners which are sometimes used in these industrial sectors. In this way better combustion conditions and better energy efficiency can be achieved.

By using this method it is possible to apply CHP in processes where heat of high temperature level is needed to be generated decentralised and to be locally controllable. Environmental benefits are also significant as the use of the fuel is performed at high efficiencies.

1. Method for the cogeneration of Heat and Power where, an independed from the heat consuming process Electricity Generating Device—EGD—e.g. a gas turbine or a recuperative gas turbine or a reciprocating engine etc. set—is connected with the process where the heat and the exhaust gases—not clean air—generated by the device is used and where EGD exhaust gases is used as oxidiser to burn additional fuel. The method is characterised by the increase of the EGD exhaust gases temperature by the cooling of the hot processed material or the hot exhaust gases generated in the heat consuming process—i.e. in the kiln or the furnace—before the EGD exhaust gases are used as oxidiser to burn additional fuel in the kiln(s) and the furnace(s) in e.g. the ceramics, heavy-clay, glass, metal/steel processing and cement industry where the material processed should be heated to temperatures which are considerably higher (say more than 150° C.) than the temperature of the exhaust gases exiting the EGD.

2. A method as described in claim 1 which is characterised by the increase of the temperature of part or all of the EGD exhaust gases to a temperature higher than the one at the exit of the EGD, before they are used as oxidiser in the kiln, in a heat exchanging process in touch with the hot material exiting the firing zones of the process.

3. A method as described in claim 1 which is characterised by the increase of the temperature of part or all of the EGD exhaust gases to a temperature higher than the one at the exit of the gas-turbine set, before they are used as oxidiser in the kiln, in a heat exchanging process via a heat exchanger by the hot material exiting the firing zones of the process.

4. A method as described in claim 1 which is characterised by the increase of the temperature of part or all of the EGD exhaust gases to a temperature higher than the one at the exit of the EGD, before they are used as oxidiser in the kiln, in a heat exchanging or regenerating process by the hot exhaust gases exiting the firing zones of the process.

5. A method as described in claim 1 which is characterised by the upgrating of the oxygen content of part or all of the EGD exhaust gases which are used as oxidiser, with pure oxygen or even air at various flow-rates and temperatures in order to achieve better combustion conditions.

6. A method as described in claim 1 which is characterised by the use of the EGD exhaust gases in an hybrid scheme i.e. part as oxidiser in the kiln and part for conventional heating purposes.

7. Burners which are suitable for applications in the industrial sectors described in claim 1 which are characterised by operating, because of the low shear rates used in the ignition regions of the burner, with lean oxygen oxidiser with an oxygen content as low as 10% weight.

8. A method as described in claim 1 where EGD exhaust gases are used as oxidiser either by small or by large burner(s) located at the heat consuming process.

9. A method as described in claim 1 and 8 where EGD exhaust gases are used as oxidiser in regenerative, radiant, porous, or flameless combustion processes and/or burners.

10. A method as described in claim 1 and 8 or 9 where EGD exhaust gases or a part of them are used as oxidiser indirectly i.e. not fed within the burners used in the process but directly into the kiln or the furnace chamber where all or part of the combustion takes place.
